(19) United States
(12) Patent Application Publication
(10) Pub. No.: US 2011/0300347 A1
(43) Pub. Date: Dec. 8, 2011

(54) Fabrication of Patterned Nanofibers

(75) Inventors: Yong Kyu Yoon, Gainesville, FL (US); Gloria J. Kim, Gainesville, GA (US); Gwan-Ha Kim, Soekwoodong (KR)

(73) Assignee: UNIVERSITY OF FLORIDA RESEARCH FOUNDATION, INC., Gainesville, FL (US)

(21) Appl. No.: 13/153,712

(22) Filed: Jun. 6, 2011

Related U.S. Application Data
(60) Provisional application No. 61/351,893, filed on Jun. 6, 2010.

(51) Int. Cl. B32B 3/00; H05B 6/00; B82Y 40/00

(52) U.S. Cl. 428/195.1; 264/464; 264/433; 977/882

(57) ABSTRACT

Various methods and systems are provided for the fabrication of patterned nanofibers. In one embodiment, a method includes generating a layer of electrospun nanofibers from a polymer solution and patterning the layer of electrospun nanofibers using ultraviolet (UV) lithography. The patterned electrospun nanofibers may then be thermally treated to form patterned carbon nanofibers. In another embodiment, a device includes a layer of patterned carbon nanofibers formed by generating electrospun nanofibers from a polymer solution, patterning the electrospun nanofibers using UV lithography, and converting the patterned electrospun nanofibers into patterned carbon nanofibers using a thermal treatment. In another embodiment, a method includes depositing electrospun nanofibers for a first predefined period of time, dissipating charge on the deposited electrospun nanofibers for a second predefined period of time where no electrospun nanofibers are deposited, and sequentially repeating the depositing and dissipating steps to from a layer of electrospun nanofibers having a predefined thickness.

### CROSS REFERENCE TO RELATED APPLICATIONS

This application claims priority to copending U.S. provisional application entitled “LITHOGRAPHICAL PATTERNING AND CARBONIZATION OF ELECTROSPUN SU-8 NANOFIBERS FOR A HIGH CAPACITY ELECTRODE” having Ser. No. 61/351,893, filed Jun. 6, 2010, the entirety of which is hereby incorporated by reference.

### STATEMENT REGARDING FEDERALLY SPONSORED RESEARCH OR DEVELOPMENT

This invention was made with government support under agreements ECCS 0748153 and CMMI 0826434 awarded by the National Science Foundation. The Government has certain rights in the invention.

### BACKGROUND

Electrospinning provides a simple and a cost effective method for generating thin fibers from various materials that include polymers, composites, and ceramics. The thin diameter of the spun fibers provides a large surface area to volume ratio and superior mechanical performance that makes them desirable for biomedical, chemical, and nanotechnology applications such as filtration of submicron or nanomaterials, separators, tissue scaffolding, drug delivery systems, artificial organs, and so on.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a graphical representation of an example of an electrospinning system in accordance with various embodiments of the present disclosure.

FIGS. 2A-2D are graphical representations of the production process of a patterned electrode using the electrospinning system of FIG. 1 in accordance with various embodiments of the present disclosure.

FIGS. 3A and 3B are scanning electron microscopy (SEM) images of examples of patterned electrospun nanofibers in accordance with various embodiments of the present disclosure.

FIG. 4 is an example of a plot of the variation of average diameter of electrospun fiber as a function of distance between needle and collector of FIG. 1 at various applied voltages in accordance with various embodiments of the present disclosure.

FIG. 5 is an example of a plot of the distribution of fiber diameters obtained from electrospinning with different concentrations of solution of FIG. 1 in accordance with various embodiments of the present disclosure.

FIG. 6 is an example of a plot of electrospun fiber layer thickness with multiple intermittent periods of continuous deposition and uninterrupted continuous deposition of electrospun fibers of FIG. 1 in accordance with various embodiments of the present disclosure.

FIGS. 7A and 7B are SEM images of examples of patterned carbon nanofibers in accordance with various embodiments of the present disclosure.

FIG. 8 is an example of an Auger electron microscopy (AES) surface scan of carbon nanofibers after pyrolysis of electrospun nanofibers in accordance with various embodiments of the present disclosure.

FIG. 9 is an example of a plot of the resistivity of a pyrolyzed layer of carbon nanofibers at different pyrolysis temperatures in accordance with various embodiments of the present disclosure.

FIGS. 10A-10D are graphical representations of devices having p-n junctions formed by doping of different layers of the electrospun nanofibers using the electrospinning system of FIG. 1 in accordance with various embodiments of the present disclosure.

FIG. 11 is a flowchart illustrating the production of patterned carbon nanofibers using the electrospinning system of FIG. 1 in accordance with various embodiments of the present disclosure.

### DETAILED DESCRIPTION

Disclosed herein are various embodiments of methods and systems related to the fabrication of patterned nanofibers. Reference will now be made in detail to the description of the embodiments as illustrated in the drawings, wherein like reference numbers indicate like parts throughout the several views.

Electrospun nanofibers can be collected as two-dimensional membranes with randomly arranged structures and small bulk thickness and utilized as devices and electrodes for high density energy storage applications such as, but not limited to, microbatteries and supercapacitors as well as in electronics including solar cells, diodes, and transistors. However, efficient micro scale patterning of such randomly grown electrospun nanofibers can limit their applicability for many uses in biomedical, chemical, and nanotechnology. For example, a dexterous fabrication technique may be used for the patterning of electrospun nanofibers. Alternatively, a static method may be used to fabricate ultrafine electrospun nanofibers in three dimensional (3-D) fibrous tubes. The nanofibers can be uniaxially aligned by introducing an insulating gap into the conductive collector. However, these methods are generally incompatible with the UV lithography techniques that are usually employed to accurately pattern 3-D microstructures.

In addition, while the electrical characteristics of fibers formed from conductive polymers, such as polyaniline, polypyrrole, and polyethylene oxide, have attracted interest, these electrically conductive fibers exhibit a relatively high resistivity. In contrast, the carbonization of SU-8 microstructures provides outstanding electrical, mechanical and chemical performance. Bulk electrospun SU-8 nanofibers may be prepared using multiple times continuous growing and patterned with an ultraviolet (UV) lithography process. Carbonization of the nanofibers may then be carried out. This approach allows for microscopic patterning in a process that is compatible with semiconductor processes.

A three-step process may be used for fabricating micropatterned conductive nanofibers for a high capacity application in energy storage devices or electronic devices. The three steps include: (1) generation of electrospun nanofibers with a photopatternable negative tone epoxy such as, e.g., SU-8; (2) precise lithographical microscopic patterning of the SU-8 nanofibers; and (3) thermal treatment of the patterned nanofibers in an inert environment to carbonize the SU-8 structure.

Electrospinning is a technique that can be used to produce a large number of nanofibers in macro lengths. The standard electrospinning technique subjects a polymer solution to high voltages while it is squeezed through a nozzle and collected on a grounded plate at an appropriate distance to produce nanofibers. Polymer solutions include photosensitive polymers such as, but not limited to, SU-8, NR9 8000, LF55GN, AZ4620, etc. Random nanofibers of photopatternable epoxy can be fabricated using the electrospinning process under various conditions. For example, SU-8 2025 can be diluted using cyclopentanone in a range of a concentration of about 60.87% to about 68.55% (by weight). The prepared solutions may be stored at room temperature and all processes can be carried out at room temperature in air.

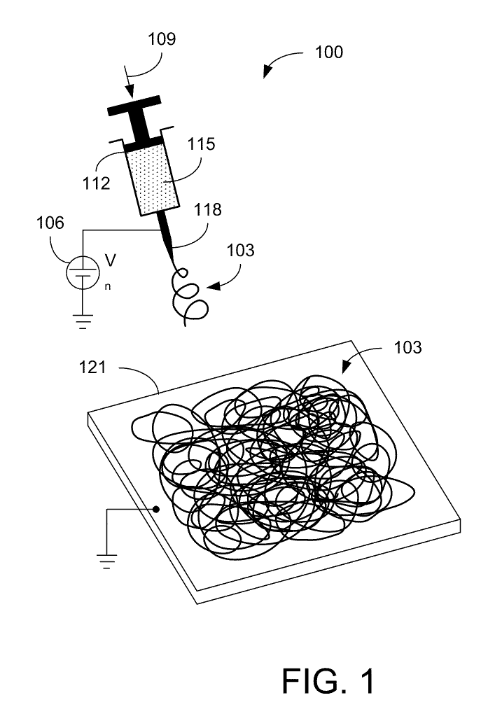

Referring to FIG. 1, shown is a graphical representation of an electrospinning system 100 illustrating the electrospinning of nanofibers 103. For example, a setup used for the electrospinning process can include an adjustable DC power supply 106 (e.g., a DEL HVPS MOD 603 30 KV POS, Spellman High Voltage Electronic Corp., USA) capable of generating DC voltage in a range of about 0-30 kV and a syringe pump 109 (e.g., a NE-1000, New Era Pump Systems, Inc., USA) on which a 5 ml syringe 112 filled with a polymer solution 115 is connected with a stainless steel needle 118 having an inner diameter of about 0.2 mm. The working distance between the needle 118 and the collector 121 may be in a range of about 7.5-25 cm. The collector 121 may comprise a substrate upon which the electrospun nanofibers 103 are deposited. Positive voltages applied to the solution 115 (e.g., SU-8) are in a range of about 12.5-17.5 kV. The solution flow rates are controlled by a syringe pump 109 with a pumping rate of about 0.02 ml/min. The resulting electrospun nanofibers 103 can have diameters ranging from about 340 nm to about 3.3 μm, depending upon the different electrospinning conditions. The diameter of SU-8 electrospun nanofibers can be measured by a field emission scanning electron microscopy (FE-SEM) system (e.g., a SU-70, Hitachi, Japan).

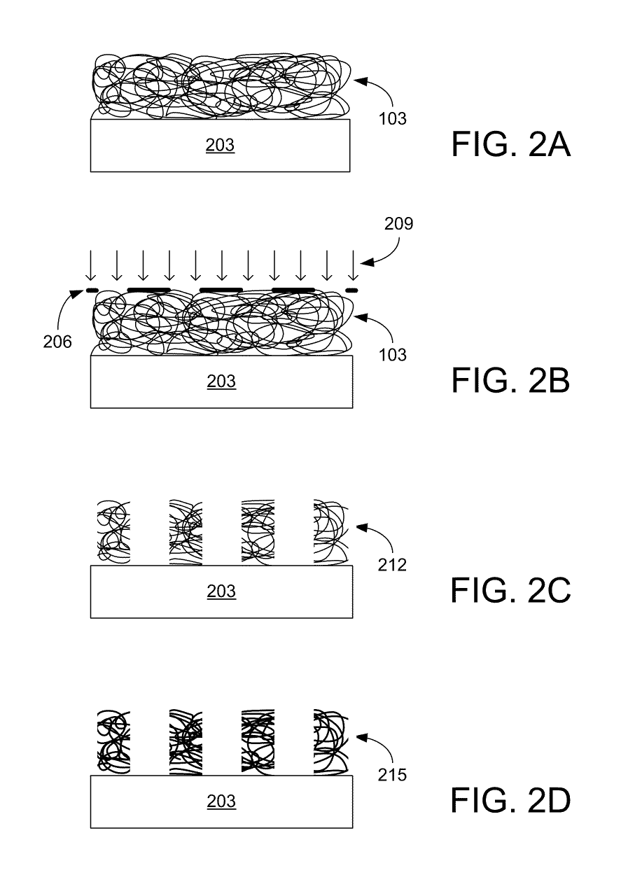

Referring to FIGS. 2A-2D, shown is graphical representation of the fabrication of a patterned electrode. Beginning with FIG. 2A, a thick stack of electrospun SU-8 nanofibers 103 is deposited on a substrate 203 (e.g., a Si or GaAs substrate). A multiple intermittent electrospinning scheme may be used to stack nanofibers as thick as 80 μm, thereby providing three dimensional (3-D) nanofiber electrodes. This thickness can be further increased by repeating the scheme.

A photo mask 206 is then formed over the electrospun nanofibers 103 in the desired pattern in FIG. 2B and exposed to ultraviolet (UV) radiation 209 (e.g., λ=365 nm) to polymerize the nanofibers 103 during patterning, followed by a post exposure bake. A UV exposure system (e.g., a LS30, OAI, Inc) may be been used for the patterning of electrospun nanofibers 103. An additional process like micro molding or a reactive ion etching process is not necessary after lithography to produce the patterned nanofibers 212 in FIG. 1C. After the patterned electrospun nanofibers 212 are developed, the nanofibers 103 and substrate 203 undergo pyrolysis in FIG. 2D. The patterned electrospun SU-8 nanofibers 212 are converted into patterned carbon nanofibers 215 by the pyrolysis process.

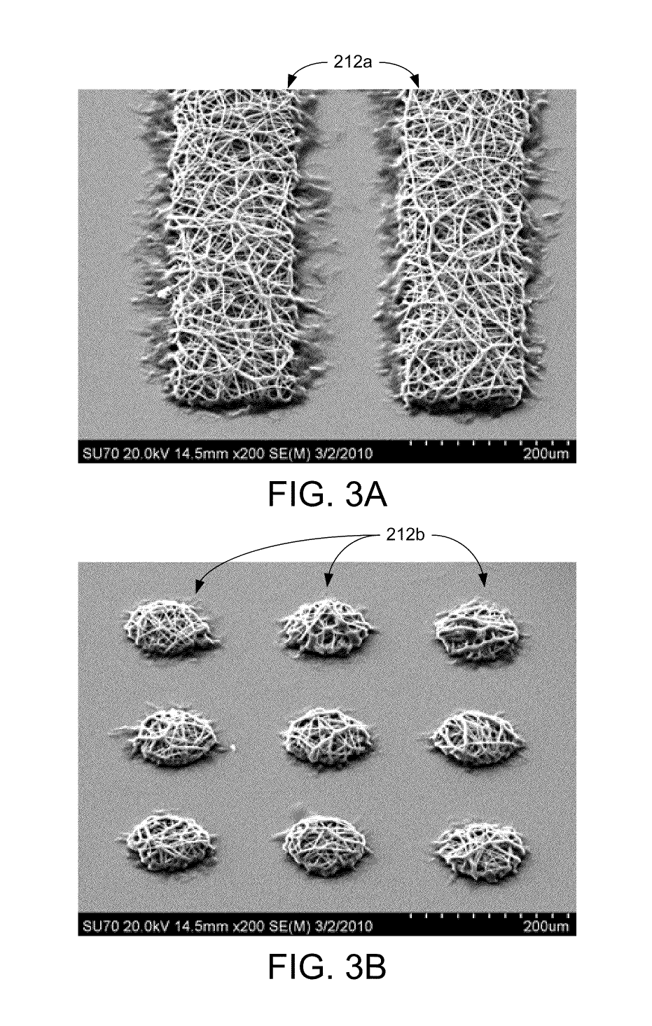

Referring to FIGS. 3A and 3B, shown are SEM images of examples of patterned electrospun nanofibers 212a and 212b such as (a) a line with a width of 120 μm and (b) a circle with a diameter of 100 μm, respectively. Other patterns and geometries may be formed using other photo mask patterns as can be understood. While some edges of the patterned electrospun nanofibers 212 look rough because of the edge of some nanofibers, the overall shape conforms with the original photo mask geometry with good fidelity.

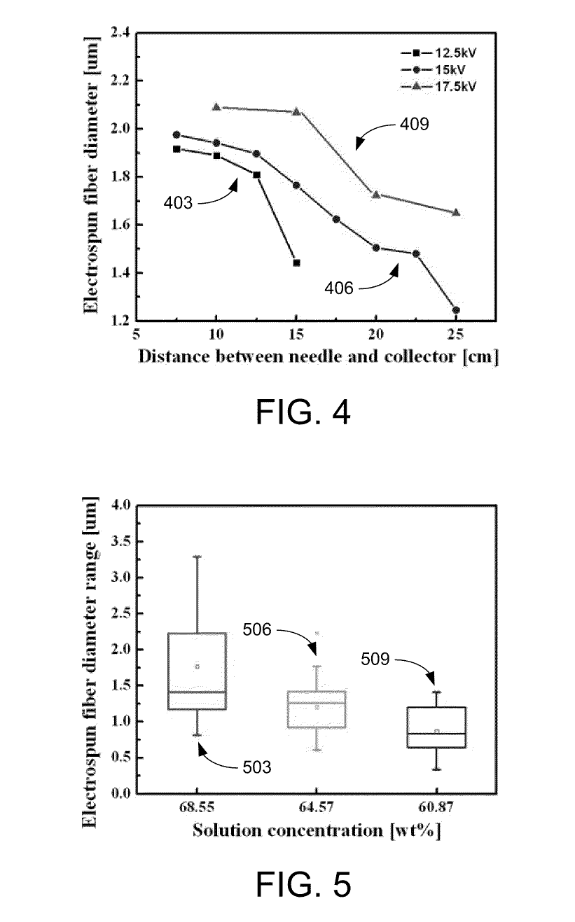

Parameters of the electrospinning system 100 of FIG. 1 may be varied to control the size of the electrospun nanofibers 103 (FIG. 1). For example, controlled variables such as the applied voltage and working distance between the needle 118 (FIG. 1) and the collector 121 (FIG. 1) may be varied. Referring to FIG. 4, shown is an example of a plot of the variation of average diameter of the electrospun fiber 103 as a function of the distance between the needle 118 and the collector 121 at various applied voltages (curve 403 at 12.5 kV, curve 406 at 15 kV, and curve 409 at 17.5 kV). The average diameter of the electrospun nanofibers 103 becomes smaller as the travel distance increases due to: (i) more time for solvent evaporation, and (ii) continuous stretching by electrostatic force. As the working distance increases, the average diameter of electrospun fibers 103 decreases. A minimum distance allows the electrospun fibers 103 to have sufficient time to remove solvent before reaching the collector 121.

In addition, FIG. 4 illustrates that the average diameter of the electrospun fibers 103 increases when a higher voltage is applied. In the case of a SU-8 solution 115 (FIG. 1), higher voltages yield larger fiber diameters. In electrospinning, the charge transport under the applied electric field is the main mechanism for electrospun fiber deposition. This is attributed to the mass flow of the SU-8 solution 115 from the tip of the needle 118. An increase in the voltage applied by the power supply 106 causes a change in the shape of the jet initiating point, and hence the structure and morphology of the electrospun nanofibers 103. With SU-8, the diameter of the electrospun fibers 103 largely varies depending upon the applied voltage.

The concentration of the polymer solution 115, along with the viscosity and surface tension affects the formation of the electrospun fibers 103. Referring now to FIG. 5, shown is an example of a plot of the distribution of fiber diameters obtained from electrospinning with three different concentrations of SU-8 solution 115 (range 503 at 68.55 wt %, range 506 at 64.57 wt %, and range 509 at 60.87 wt %) while all other variables were held constant. As can be seen from FIG. 5, a decrease in the solution concentration results in electrospun nanofibers 103 with smaller diameters. Decreasing the concentration of a SU-8 solution 115 may also affect its surface tension. Solution properties may also be varied to effect the diameter of the electrospun nanofibers 103 for other polymeric systems. SU-8 has a linear relationship between solution concentration and resulting fiber diameter. The increase in viscosity resulting from the increased concentration causes this effect.

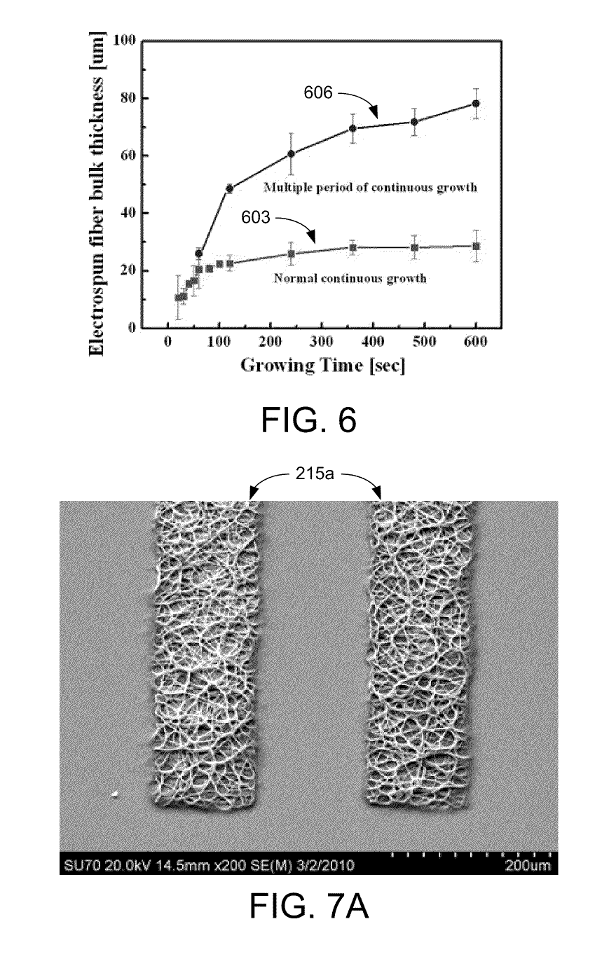

Referring next to FIG. 6, shown are an example of a plot of two electrospinning conditions: multiple intermittent periods of continuous deposition (or growth) 603 and uninterrupted continuous deposition (or growth) of electrospun fibers 606. For up to about 60 seconds of growth time, curve 603 illustrates a linear increase in the thickness of the sheets of SU-8 electrospun fiber 103 (FIG. 1). However, a plateau is reached after 60 seconds as shown in the uninterrupted continuous growth plot 603. This is attributed to a buildup of positive charge on the collector 121 (FIG. 1) due to the slow discharge of the positive ions through the nonconducting nanofibers. Accumulated positive ions in the deposited electrospun fibers 103 repel subsequent nanofibers 103, preventing further growth.

This charge repelling phenomenon is dramatically relieved by introducing multiple intermittent periods of continuous growth as illustrated by curve 606. For example, during a deposition interval the electrospinning process is applied for about 30 seconds followed by a rest interval of about 30 seconds before repeating the next electrospinning step. The charge in the electrospun fibers 103 is allowed to slowly dissipate during the rest period. In this way, the repelling force is significantly reduced and a thick stack of electrospun fiber 103 of, e.g., greater than 40 μm can be achieved. In the examples of FIG. 6, up to 80 μm may be achieved after twelve 30 second cycles. This thickness may be further increased by continued repeating the scheme.

The production of thick electrospun nanofiber sheets with high fiber packing density and high porosity allows for the production of three dimensional (3-D) nanofiber structures, which are advantageous for applications in energy storage, electronics, and biomedical devices. After appropriate buildup, the electrospun nanofibers 103 may be patterned through direct application of UV lithography. For micro/nanometer scale integrated devices, accurate patterning of layers of electrospun fibers 103 using UV lithography that is compatible with other semiconductor processes is a useful feature. The patterned electrospun fibers 212 (FIG. 2) are then converted into patterned carbon nanofibers 215 (FIG. 2) by pyrolysing. The carbon nanofibers offer advantages in energy sources and storage cells due to their enhanced conductivity and high aspect ratio.

Referring next to FIGS. 7A and 7B, shown are SEM images of examples of patterned carbon nanofibers 215a and 215b such as (a) a line with a line width of 120 μm and (b) a circle with a diameter of 100 μm, respectively, that were obtained after pyrolysis in a nitrogen purged quartz tube furnace. The conversion of the patterned electrospun nanofibers 212 into carbon nanofibers 215 by pyrolysing results in chemically and mechanically stable, low cost, high surface area electrodes or other devices. Carbon nanofiber reinforced composites offer increased stiffness, high strength and low electrical resistivity, which are advantageous in the development of high-density and fast-response batteries and super capacitors.

The resistivity of carbonized SU-8 thin films can be measured using a four-point probe head (e.g., a C4S, Cascade Microtech, Inc., USA), a current source (e.g., a HP 6177C, HP, USA), a current meter (e.g., a 194A, Keithley Instruments Inc., USA), and a voltage meter (e.g., a 195A, Keithley Instruments Inc., USA), at room temperature. Auger electron microscopy (AES) analysis (e.g., using a Microlab 310-D, Thermo VG Scientific, USA) can be conducted to verify the change in the composition of the electrospun nanofibers 103 after pyrolysis.

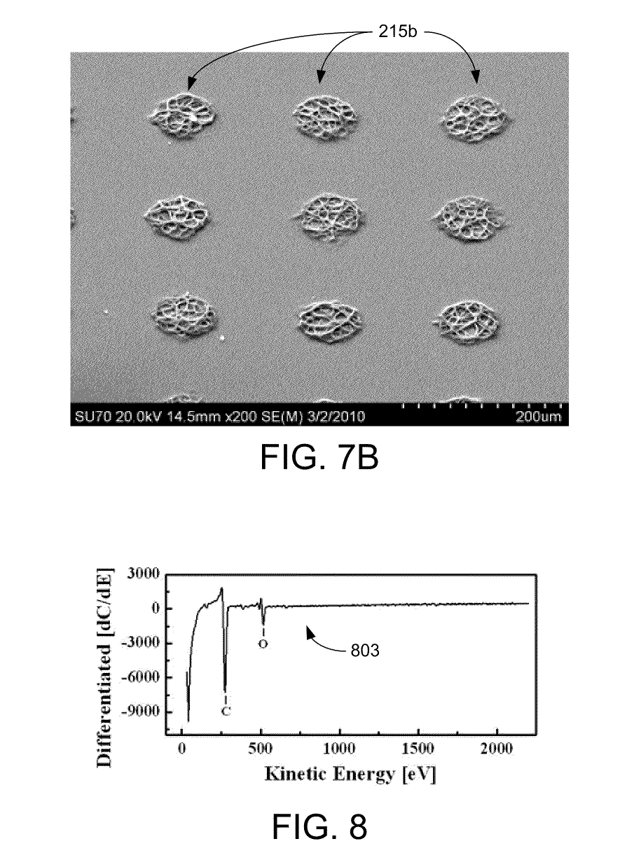

Referring to FIG. 8, shown is an Auger electron microscopy (AES) surface scan 803 of a carbon nanofiber layer after the pyrolysis of a thin layer of SU-8 electrospun nanofibers 103. The plot illustrates that all the polymer components in SU-8 electrospun nanofibers 103 have been converted into carbon. The existence of the oxygen element may be due to the exposure of the sample in air before and during AES analysis.

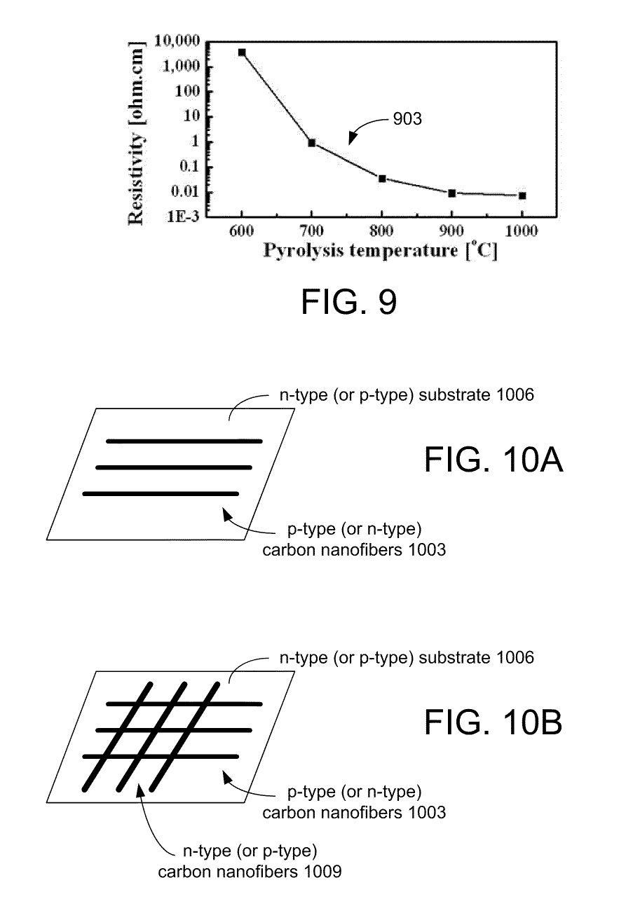

Referring next to FIG. 9, shown is an example of a plot of the resistivity of the pyrolyzed layer of carbon nanofibers 215 at different pyrolysis temperatures. Curve 903 illustrates the decrease in resistivity as the pyrolysis temperature increases. The decrease in resistivity with an increase in temperature may be attributed to the degree of graphitization. The higher the temperature of pyrolysis, the greater the extent of graphitization, and thus the lower the resistivity.

When the pyrolysis temperature is in the range of about 600° C. to about 1000° C., the resistivity values range between about 3000 and about 0.01 ohm·cm, which is consistent with a typical semiconductor resistivity range of Si or GaAs substrates. In some implementations, the temperature may be controlled to obtain a desired overall resistivity. In addition, additives can be included in the polymer solution 115 to make a p-type or n-type carbon material. For example, boron or aluminum may be added to the polymer precursor for electrospinning nanofibers containing boron and aluminum dopants. After pyrolysis, the carbonized nanofibers will be formed as p-type semiconductor. If nitride or phosphorous is added to the polymer precursor, the resulting carbon nanofibers will be n-type semiconductor. The polymer pyrolysis process will be able to control the doping level (or dose) during the precursor preparation. Once pyrolysis is performed at the predetermined temperature, a desired semiconductor type is produced with required doping levels. If the carbon is formed in an individual nanofiber form with assistance of electrospinning, the resulting carbon nanofiber has an individual current path, which can result in semiconductor devices with great suppression of cross talk between channels and minimized noise.

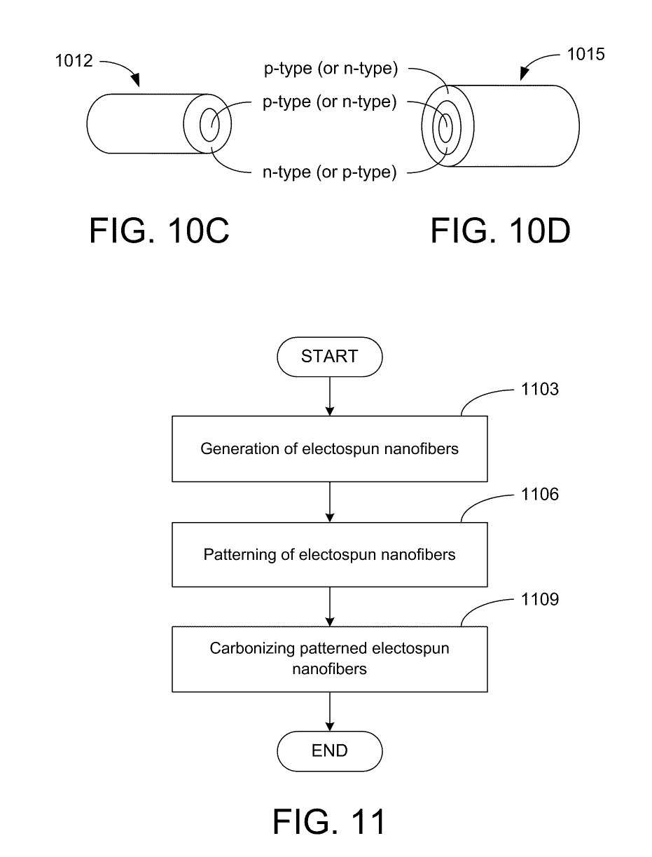

Referring to FIGS. 10A-10D, doping of different layers of the electrospun nanofibers may be utilized to form p-n junctions. For example, in FIG. 10A, n-type (or p-type) carbon nanofibers 1003 may be formed on a p-type (or n-type) substrate 1006 to provide a p-n junction. In FIG. 10B, an additional layer of p-type (or n-type) carbon nanofibers 1009 may be added to form a p-n-p (or n-p-n) device. This allows to make a carbon nanofiber based electronic diode or transistor, which will have broad applications on photovoltaic devices (solar cell), amplifiers, and logic devices. The ability to pattern the multilayer carbon nanofibers provides a geometrical controllability that is not available devices produced with carbon nanotubes or graphene. Other architectures may also be possible. If two polymer precursors are used to produce two different electrospun fibers that are in contact with each other, a p-n junction may be formed. For example, FIG. 10C illustrates a concentric p-n diode 1012 and FIG. 10D depicts a concentric p-n-p (or n-p-n) transistor 1015. Applications of the carbon nanofiber based semiconductors can include, but are not limited to, solar cells, memory devices, amplifiers, and large energy storage devices.

Referring now to FIG. 11, shown is a flow chart illustrating the production of patterned carbon nanofibers in accordance with various embodiments of the present disclosure. The patterned carbon nanofibers may be produced to form electrodes and devices including one or more p-n junction(s). Beginning with block 1103, electrospun nanofibers 103 (FIG. 1) are generated to form an electrospun nanofiber layer, e.g., on a substrate 203 (FIG. 2). In some implementations, the layer may be produced by multiple intermittent periods of continuous growth or deposition to increase the thickness. In some embodiments, a plurality of electrospun nanofiber layers may be formed with adjacent layers including nanofibers electrospun from different polymers or doped polymers. For example, a first layer may include p-type electrospun nanofibers and a second layer may include n-type electrospun nanofibers. In some cases, the substrate may also be a p-type or n-type material.

In block 1106, the electrospun nanofibers are patterned using UV lithography. A photo mask 206 (FIG. 2B) is patterned over the electrospun nanofibers 103 and exposed to UV radiation to pattern the underlying electrospun nanofibers 103. The exposure may be followed by a post exposure bake. The exposed material is developed leaving the patterned electrospun nanofibers 212 (FIG. 2C). In some implementations, multiple layers of electrospun nanofibers 103 may be formed in block 1103 and then patterned at the same time in block 1106. In other implementations, an electrospun nanofiber layer may be patterned in block 1106, followed by returning to block 1103 to generate another layer of electrospun nanofibers 103 over the patterned electrospun nanofiber layer. The newly formed electrospun nanofiber layer (with the underlying patterned electrospun nanofiber layer) may then be patterned in block 1106. The electrospun nanofibers in each layer may be generated from the same or different solutions. Other combinations of generating (block 1103) and patterning (block 1106) may be used to form other structures and patterns as can be understood.

The patterned electrospun nanofibers 212 are carbonized in block 1109. The patterned electrospun nanofibers are converted into patterned carbon nanofibers 215 (FIG. 2D) by thermal treatment such as, e.g., a pyrolysis process. As discussed above, the characteristics of the carbon nanofibers may be controlled based upon the size and composition of the electrospun nanofibers as well as variables such as time and temperature of the pyrolysis process. The patterned carbon nanofibers 215 may be used as electrodes or other devices including p-n junctions.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method, comprising:
generating a layer of electrospun nanofibers from a polymer solution; and
patterning the layer of electrospun nanofibers using ultraviolet (UV) lithography.

2. The method of claim 1, further comprising thermally treating the patterned electrospun nanofibers to form patterned carbon nanofibers

3. The method of claim 2, wherein the patterned electrospun nanofibers are thermally treated using a pyrolysis process.

4. The method of claim 3, wherein the pyrolysis process is carried out at a predefined temperature, where the predefined temperature corresponds to a resistivity of the carbon nanofibers.

5. The method of claim 1, wherein patterning the layer of electrospun nanofibers comprises:
forming a photo mask over the layer of electrospun nanofibers; and
exposing the photo mask and the layer of electrospun nanofibers to UV radiation to polymerize the electrospun nanofibers.

6. The method of claim 1, wherein the layer of electrospun nanofibers is generated by multiple intermittent periods of continuous deposition of electrospun nanofibers.

7. The method of claim 6, wherein each intermittent period includes a first predefined interval including deposition of the electrospun nanofibers followed by a second predefined interval without deposition of the electrospun nanofibers.

8. The method of claim 7, wherein the first predefined interval and the second predefined interval are equal.

9. The method of claim 1, wherein the layer of electrospun nanofibers is deposited on a substrate.

10. The method of claim 1, wherein the polymer solution comprises SU-8.

11. The method of claim 1, wherein the polymer solution includes an additive to form p-type electrospun nanofibers.

12. The method of claim 1, further comprising generating a second layer of electrospun nanofibers over the patterned electrospun nanofibers.

13. The method of claim 12, further comprising patterning the second layer of electrospun nanofibers using ultraviolet (UV) lithography.

14. The method of claim 12, wherein the electrospun nanofibers of the second layer different than the electrospun nanofibers of the patterned layer.

15. The method of claim 1, wherein a plurality of layers of electrospun nanofibers are generated before patterning the plurality of layers of electrospun fibers.

16. A device, comprising:
a layer of patterned carbon nanofibers formed by:
generating electrospun nanofibers from a polymer solution;
patterning the electrospun nanofibers using ultraviolet (UV) lithography; and
converting the patterned electrospun nanofibers into patterned carbon nanofibers using a thermal treatment.

17. The device of claim 16, further comprising a second layer of carbon nanofibers in contact with the first layer of patterned carbon nanofibers, the carbon nanofibers of the first and second layers forming a p-n junction.

18. The device of claim 17, further comprising a third layer of carbon nanofibers in contact with the second layer of carbon nanofibers, wherein the first, second, and third layers of carbon nanofibers form a p-n-p or a n-p-n device.

19. A method, comprising the steps of:
depositing electrospun nanofibers for a first predefined period of time;
dissipating charge on the deposited electrospun nanofibers for a second predefined period of time where no electrospun nanofibers are deposited; and
sequentially repeating the depositing and dissipating steps to from a layer of electrospun nanofibers having a predefined thickness.

20. The method of 19, wherein the first predefined period of time and the second first predefined period of time are not the same.
